(19) United States
(12) Patent Application Publication
(10) Pub. No.: US 2019/0317382 A1
(43) Pub. Date: Oct. 17, 2019

(54) BLADE DRIVING DEVICE, IMAGING DEVICE AND ACTUATOR COMPRISING THE BLADE DRIVING DEVICE

(71) Applicant: NIDEC COPAL CORPORATION, Tokyo (JP)

(72) Inventor: Ryosuke USHIO, Tokyo (JP)

(73) Assignee: NIDEC COPAL CORPORATION, Tokyo (JP)

(21) Appl. No.: 16/469,870

(22) PCT Filed: Nov. 24, 2017
(86) PCT No.: PCT/JP2017/042243

§ 371 Date: Jun. 14, 2019

(30) Foreign Application Priority Data
Dec. 15, 2016 (JP) 2016-242927

(51) Int. Cl. G03B 9/10; G03B 9/58; H04N 5/33

(52) U.S. Cl. CPC G03B 9/10; H04N 7/181; H04N 5/33; G03B 9/58

(57) ABSTRACT

A blade driving device having a base plate with an opening for an optical path; first and second blades, at different locations on the base plate, and each rotate to open/close the opening. A first magnet secured to the first blade; a second magnet secured to the second blade; a yoke secured on the base plate; and a first and second coil coiled on the yoke. The yoke has a first magnetic pole portion adjacent to the first magnet, a second magnetic pole portion adjacent to the second magnet, and connecting portions, connecting the first magnetic pole portion and the second magnetic pole portion. The first magnetic pole portion and the second magnetic pole portion have, respectively, adjacent pieces and adjacent to the corresponding magnets, and extending portions and continuous with the adjacent pieces and provided extending in a direction perpendicular to the blade supporting face of the base plate.

### FIELD OF TECHNOLOGY

The present invention relates to a blade driving device for opening and closing, through blades, an opening for an optical path, and to an imaging device and an actuator comprising this blade driving device.

### BACKGROUND

Conventionally, as this type of invention, there is been, as described in Japanese Unexamined Patent Application Publication 2012-78502, for example, a shutter mechanism for a camera, comprising: a base plate that has an opening portion for an optical path; a plurality of shutter blades for opening/closing the opening portion through each rotating at different positions over the base plate; and a driving source structured from a rotor, a coil, a yoke, and the like.

In this type of prior art, shutter blades for driving have been rotated by driving pins that are integrated with the rotor, to rotate other shutter blades, through driving linkage portions provided on these shutter blades for driving.

### SUMMARY

Given this prior art, the rotational force of the rotor is relayed to a plurality of shutter blades through a plurality of driving pins and driving linkage portions, and thus the power relaying structure is complex. Moreover, the driving source is provided on one side of the base plate, and the shutter blades are provided on the other side, with the base plate therebetween, and thus there is a tendency for the structure to be thick in the direction of the axis of rotation. Given this, a thinner, more compact structure is desired.

The present invention is equipped with the following structures:

A blade driving device, having a base plate that has an opening for an optical path; a first blade and a second blade, at different locations on the base plate, and that each rotate to open/close the opening; a first magnet that is secured around the axis of rotation of the first blade; a second magnet that is secured around the axis of rotation of the second blade; a yoke that is secured on the base plate; and a first coil and a second coil that are coiled on the yoke, wherein: the yoke comprises a first magnetic pole portion that is adjacent to the first magnet, a second magnetic pole portion that is adjacent to the second magnet, and a connecting portion for connecting the first magnetic pole portion and the second magnetic pole portion; and the first magnetic pole portion and the second magnetic pole portion each comprise an adjacent piece that is adjacent to the corresponding magnet, and an extending portion that is continuous with the adjacent piece and that is provided extending in a direction that is perpendicular to the blade supporting face of the base plate.

### BRIEF DESCRIPTIONS OF THE DRAWINGS

FIG. 1 depicts an example of a blade driving device according to the present invention, wherein (a) is an exterior perspective diagram viewed from the cover member side, and (b) is an exterior perspective diagram viewed from the base plate side.

FIG. 2 is an assembly perspective diagram of the blade driving device.

FIG. 3 is a perspective diagram wherein critical portions of this blade driving device are viewed from the incident light side.

FIG. 4 is a perspective diagram depicting the assembly of critical portions of the blade driving device.

FIG. 5 is a plan view depicting the blade driving device with a portion thereof omitted, wherein (a) shows the state wherein the opening is open and (b) shows the state wherein the opening is closed.

FIG. 6 is perspective diagrams showing respective examples, in (a) and (b), of imaging devices equipped with this blade driving device.

FIG. 7 is a perspective diagram depicting a mobile device equipped with this blade driving device.

### DETAILED DESCRIPTION

Examples of the present invention will be explained below in reference to the drawings. In the descriptions below, identical reference symbols in the different drawings below indicate positions with identical functions, and redundant explanations in the various drawings are omitted as appropriate.

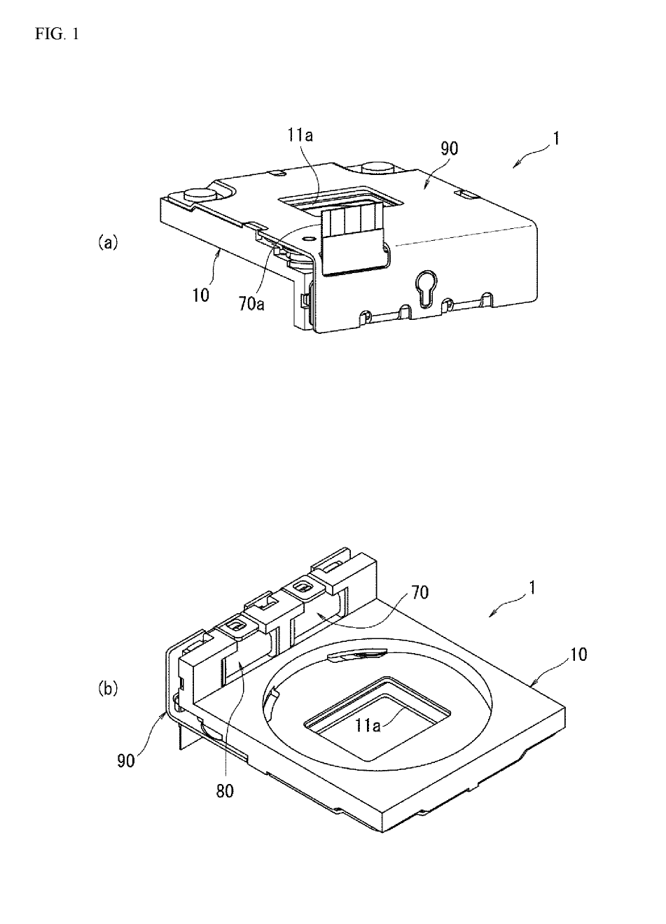

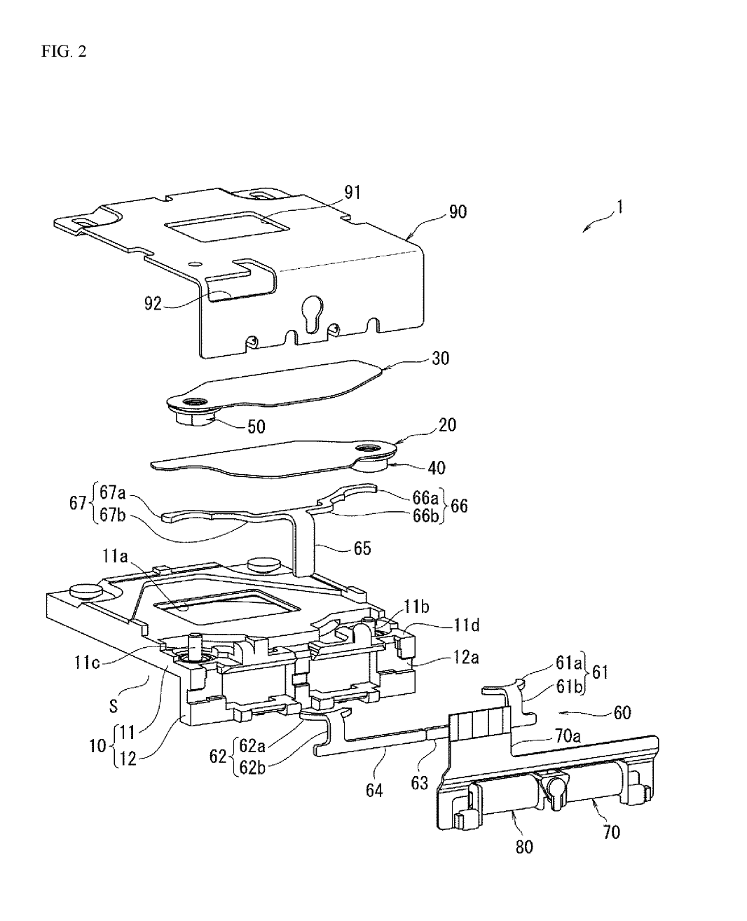

Referencing FIG. 1 and FIG. 2, this blade driving device 1 has a base plate 10, having an opening 11a for an optical path; a first blade 20 and a second blade 30, for opening/closing the opening 11a, through rotation thereof, at different positions over the base plate 10; a first magnet 40, secured around the axis of rotation of the first blade 20, and having polarities in opposing directions on two sides in the radial direction; a second magnet 50, secured around the axis of rotation of the second blade 30, having polarities in opposing directions on two sides in the radial direction; a yoke 60 that is secured to the base plate 10; a first coil 70 and a second coil 80 that are coiled onto the yoke 60; and a cover member 90.

The base plate 10 is formed in essentially a L-shape, when viewed from the side, and has a main unit portion 11 that has an opening 11a toward the center, and a supporting piece 12, for supporting the yoke 60, and the like, described below, protruding in one optical axial direction, on one end side of the main unit portion 11. A space S on the incident light side of this base plate 10 is used for assembling a lens unit, and the like, not shown.

This base plate 10 is formed as a single unit from, for example, aluminum, magnesium, another metal material, an alloy of these, or the like.

The main unit portion 11 is formed in a rectangular plate-shape, with a rectangular through hole-shape opening 11a toward the center thereof. In the example depicted in FIG. 2, the vertical direction in the figure, in the opening 11a, is the optical axial direction, formed so that light will be incident into the opening 11a.

Moreover, supporting shafts 11b and 11c are provided near the supporting piece 12 on the surface of the main unit portion 11 that is in the direction opposite of the direction in which the supporting piece 12 protrudes. The supporting shafts 11b and 11c support, respectively, the first blade 20 and the second blade 30, described below, and protrude in the direction opposite that of the supporting piece 12.

The supporting shaft 11b and 11c is each a circular column-shaped shaft that protrudes perpendicularly in respect to the surface of the main unit portion 11. In one supporting shaft 11b, the outer peripheral surface makes sliding contact with the inner peripheral surface of the first magnet 40, to support the first magnet 40 so as to enable rotation. Similarly, with the other supporting shaft 11c, the outer peripheral surface thereof makes sliding contact with the inner peripheral surface of the second magnet 50, to support the second magnet 50 so as to enable rotation.

Moreover, recessed portions 11d, which cause the thickness of the main unit portion 11 to be thinner, are provided around the supporting shaft 11b and 11c on the main unit portion 11, where the first magnet 40 and the second magnet 50, and the adjacent pieces 61a, 62a, 66a, and 67a, are fitted into the recessed portions 11d.

A fitting/supporting portion 12a, of a recessed shape, for fitting together with and securing the yoke 60, the first coil 70, the second coil 80, and the like, is provided on the outer side face of the supporting piece 12.

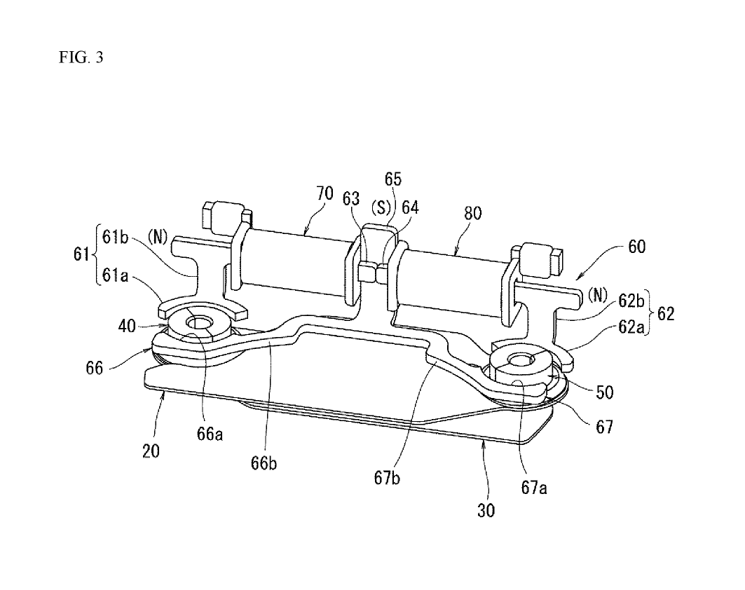

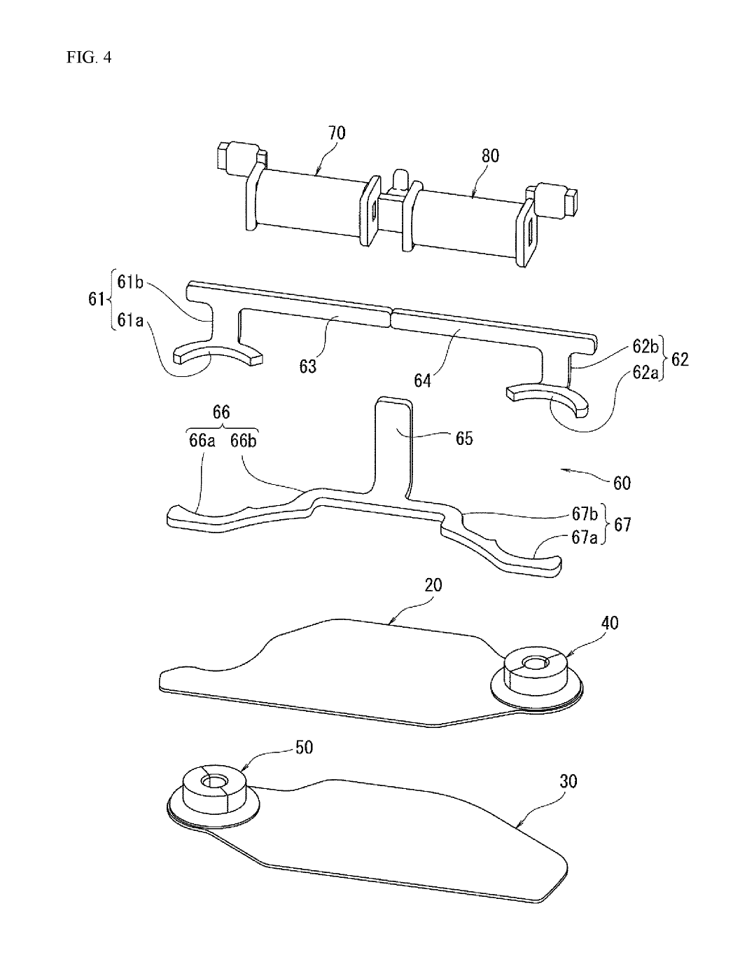

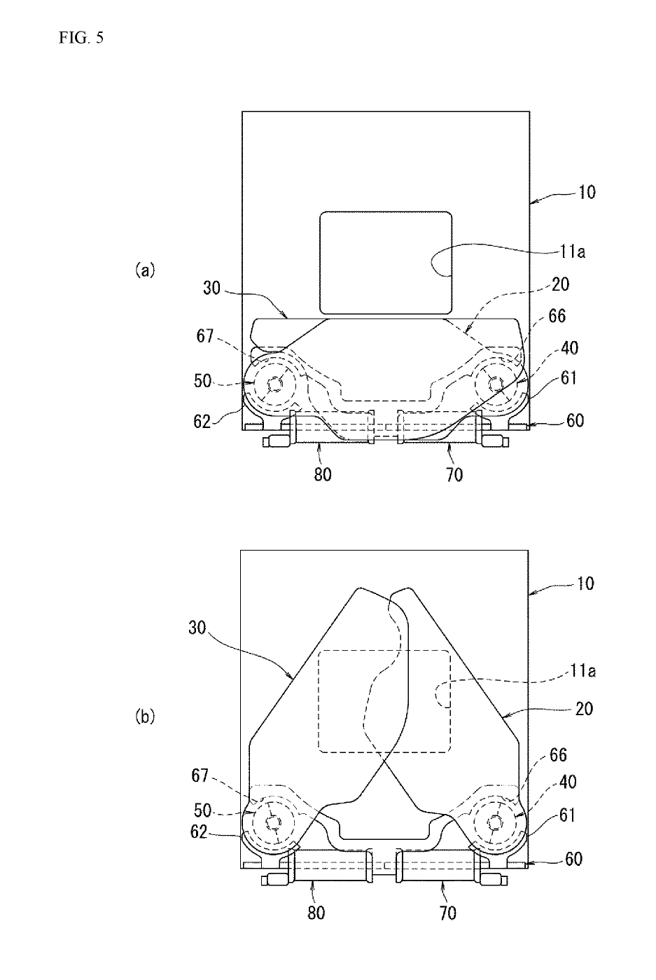

Referencing FIG. 3, FIG. 4, and FIG. 5, the first blade 20 and the second blade 30 are formed in respective thin plate shapes from, for example, aluminum alloy, or the like, and are rotated to open/close the opening 11a of the base plate 10.

In the first blade 20, the first magnet 40 is secured around the axis of rotation, on the incident light side surface, so as to rotate together therewith. Similarly, in the second blade 30 as well, the second magnet 50 is secured around the axis of rotation, on the incident light side surface thereof, so as to rotate together therewith.

The first blade 20 and the second blade 30 overlap each other partially around the first magnet 40 and the second magnet 50. In the example that is illustrated, the second blade 30 overlaps, on the side opposite from the incident light side, the first blade 20, which overlaps the base plate 10.

The first magnet 40 and the second magnet 50 are each cylindrical permanent magnets that are symmetrical in the radial direction, have mutually differing magnetic poles (north and south), and are formed from a magnetic material such as, for example, samarium cobalt, ferrite, neodymium, or the like.

The first magnet 40 is adhesively secured, through an adhesive agent, around the axis of rotation of the first blade 20, and is equipped in a ring shape so as to enable rotation in respect to the supporting shaft 11b of the base plate 10.

Similarly, the second magnet 50 is secured, through an adhesive agent, around the axis of rotation of the second blade 30, and is equipped in a ring shape so as to enable rotation in respect to the supporting shaft 11c of the base plate 10.

The yoke 60 is structured from a magnetic material, and comprises, integrally, a first magnetic pole portion 61 that is near to the first magnet 40 from one side in the radial direction; a second magnetic pole portion 62 that is near to the second magnet 50 in the radial direction; connecting portions 63 and 64 for connecting between the first magnetic pole portion 61 and the second magnetic pole portion 62; a connecting piece 65, for connecting to the vicinity of the center of the connecting portions 63 and 64; a third magnetic pole portion 66, extending from the connecting piece 65, that is near to the other side of the first magnet 40 in the radial direction; and a fourth magnetic pole portion 67 that extends from the connecting piece 65, that is near to the second magnet 50 on the other side in the radial direction.

Note that while for example, as illustrated in FIG. 4, the yoke 60 is structured as a single unit from a plurality of piece members as a form that is particularly suitable for manufacturing (referencing FIG. 4), as another embodiment of the yoke 60, it may be a member wherein some or all parts are formed integrally in advance.

The first magnetic pole portion 61 comprises, integrally: an adjacent piece 61a that is adjacent, on one side in the radial direction, to the outer peripheral surface of the corresponding first magnet 40; and an extending portion 61b, which is provided extending in the crosswise direction (the optical axial direction) in respect to the blade supporting surface of the base plate, and is continuous with the adjacent piece 61a.

The adjacent piece 61a has an arc-shaped end face that is adjacent to the outer peripheral surface of the first magnet 40, with a prescribed clearance. The extending portion 61b is a position that is bent to essentially a right angle, in respect to the adjacent piece 61a, and fits together with the fitting/supporting portion 12a.

Similarly, the second magnetic pole portion 62 comprises, integrally: an adjacent piece 62a that is adjacent, on one side in the radial direction, to the outer peripheral surface of the corresponding second magnet 50; and an extending portion 62b, which is provided extending in the crosswise direction in respect to the blade supporting surface of the base plate 10, and is continuous with the adjacent piece 62a.

The adjacent piece 62a has an arc-shaped end face that is adjacent to the outer peripheral surface of the second magnet 50, with a prescribed clearance. The extending portion 62b is a position that is bent to essentially a right angle, in respect to the adjacent piece 62a, and fits together with the fitting/supporting portion 12a.

One connecting portion 63 extends straight from the extending portion 61b toward the second magnetic pole portion 62 side, and the other connecting portion 64 extends straight from the extending portion 62b to the first magnetic pole portion 61 side. Given this, there is mutually abutting contact between the connecting portion 63 and the connecting portion 64.

The first coil 70 and the second coil 80, described below, are equipped in ring shapes on the connecting portion 63 and the connecting portion 64.

Moreover, the connecting piece 65 extends in the optical axial direction, and is connected through layering together with the contacting parts of the connecting portion 63 and the connecting portion 64, described above.

This connecting piece 65 is secured through press fitting into the fitting/supporting portion 12a of the base plate 10, together with the connecting portion 63 and the connecting portion 64.

In this way, in the yoke 60, the shape is such that a portion thereof is bent in the optical axial direction, and thus is able to reduce the size of the blade driving device 1 in the plan view in the optical axial direction.

The third magnetic pole portion 66 comprises, integrally, an arc-shaped adjacent piece 66a that is adjacent to the outer peripheral surface of the corresponding first magnet 40, with a prescribed clearance therefrom, and an extending portion 66b that extends from an end portion of the adjacent piece 66a toward the fourth magnetic pole portion 67 side.

Similarly, the fourth magnetic pole portion 67 comprises, integrally, an arc-shaped adjacent piece 67a that is adjacent to the outer peripheral surface of the corresponding second magnet 50, with a prescribed clearance therefrom, and an extending portion 67b that extends from an end portion of the adjacent piece 67a toward the third magnetic pole portion 66 side.

The extending portion 66b and the extending portion 67b are connected integrally with the connecting piece 65, described above, at the parts thereof that are toward the center (referencing, in particular, FIG. 2 and FIG. 3).

The first coil 70 is positioned between the first magnetic pole portion 61 and the connecting piece 65, and installed, in a ring shape, on the connecting portion 63.

Moreover, the second coil 80 is positioned between the second magnetic pole portion 62 and the connecting piece 65, and is installed in a ring shape on the connecting portion 64, so as to be lined up in a straight line with the first coil 70.

Given this, the first coil 70 and the second coil 80 are wired electrically so as to form a magnetic circuit wherein the first magnetic pole portion 61 and the second magnetic pole portion 62 will have the same polarity, and the connecting portions 63 and 64, which are toward the center, will have polarities that are opposite those of the first magnetic pole portion 61 and the second magnetic pole portion 62.

Explaining in greater detail, in the first coil 70 and the second coil 80, the wire materials thereof are coiled mutually opposing directions. Additionally, in the first coil 70 and the second coil 80, the terminals (not shown) at the positions that are toward the center, between the connecting portions 63 and 64 (that is, toward the connecting piece 65) are connected together electrically. In the first coil 70 and the second coil 80, the two terminals on the sides opposite from the aforementioned connecting location (that is, on the first magnetic pole portion 61 side and the second magnetic pole portion 62 side) are connected to external power supply circuits, not shown, through a terminal plate 70a (referencing FIG. 2).

Consequently, when DC electric power, or the like, is supplied to these two coils 70 and 80, the first magnetic pole portion 61 and the second magnetic pole portion 62, on one end side and the other end side of these two coils 70 and 80, will go to the same polarity (for example, the north polarity), and the connecting piece 65, to the center of these two coils 70 and 80, will go to the opposite polarity (for example, the south polarity), and, accompanying this, both the third magnetic pole portion 66 and the fourth magnetic pole portion 67 will go to the aforementioned opposite polarity (for example, the south polarity) (referencing FIG. 3).

In the state wherein the first coil 70 and the second coil 80 are installed, in the yoke 60 the adjacent pieces 61a, 62a, 66a, and 67a in the first through fourth magnetic pole portions 61, 62, 66, and 67 will be disposed on the blade supporting surface side of the base plate 10, and the extending portions 61b and 62b, the connecting portions 63 and 64, and the connecting piece 65 will be disposed on one side face side of the base plate 10 (and, specifically, at the supporting piece 12).

The cover member 90 is made from a hard material, such as, for example, a nonmagnetic stainless steel material, and is formed in a plate shape that has a cross-sectional L shape, covering, for example, the main unit portion 11 of the base plate 10 and the outer surface of the supporting piece 12.

An opening 91, that communicates with the opening 11a of the base plate 10, is formed toward the center of the cover member 90.

The cover member 90 is connected securely to the base plate 10, so as to cover the first blade 20, the second blade 30, the first magnet 40, the second magnet 50, the yoke 60, the first coil 70, the second coil 80, the terminal plate 70a, and the like, described above, where the terminal part of the terminal plate 70a is inserted through the through hole 92 (referencing FIG. 2), to be exposed on the outside.

Given this, a photodetecting element, not shown (for example, a ferroelectric sensor, a thermopile, a bolometer, or another infrared radiation sensor, a CCD image sensor, a CMOS image sensor, or the like) is equipped so as to cover the opening 91 on the side of the cover member 90 that is opposite from the incident light side.

The operating effects that are the distinctive feature of the blade driving device 1 with the structure set forth above will be explained in detail next.

When DC electric power is supplied to the two coils 70 and 80, then, as illustrated in FIG. 3, the same polarity as that of the first magnetic pole portion 61 and the second magnetic pole portion 62 (for example, the north polarity) will be produced at the one end side and the other end side of the two coils 70 and 80, and, simultaneously, both the third magnetic pole portion 66 and the fourth magnetic pole portion 67 will go to the polarity that is opposite that of the first magnetic pole portion 61 and the second magnetic pole portion 62 (for example, the south polarity), and, through the magnetic effects received from these magnetic pole portions, the first magnet 40 and the first blade 20, and the second magnet 50 and the second blade 30, will each rotate in the direction to open (or close) the opening 11a. Moreover, when the direction of the DC electric power is reversed, the first magnet 40 and first blade 20, and the second magnet 50 and second blade 30, will each rotate in the direction opposite of the direction described above.

In this way, because the magnet and blade, as a single unit, are rotated directly by the blade driving device 1, this enables smooth operation with good responsiveness, with little play, backlash, or the like, in the power transmission train, when compared to the prior art wherein the force from a single driving source is transmitted through linking pins, and the like, to a plurality of blades.

Moreover, because the first blade 20, the second blade 30, the first magnet 40, the second magnet 50, the adjacent pieces 61a, 62a, 66a, and 67a, and the like, move along the surface on one side of the base plate 10, overall the structure is thin. In particular, in the preferred example that is depicted in FIG. 2, the yoke 60 is fitted together with the part of the base plate 10 wherein one edge is bent to essentially a L-shape (specifically, the recessed portion 11d and the fitting/supporting portion 12a, and the like), to achieve a thin, compact structure.

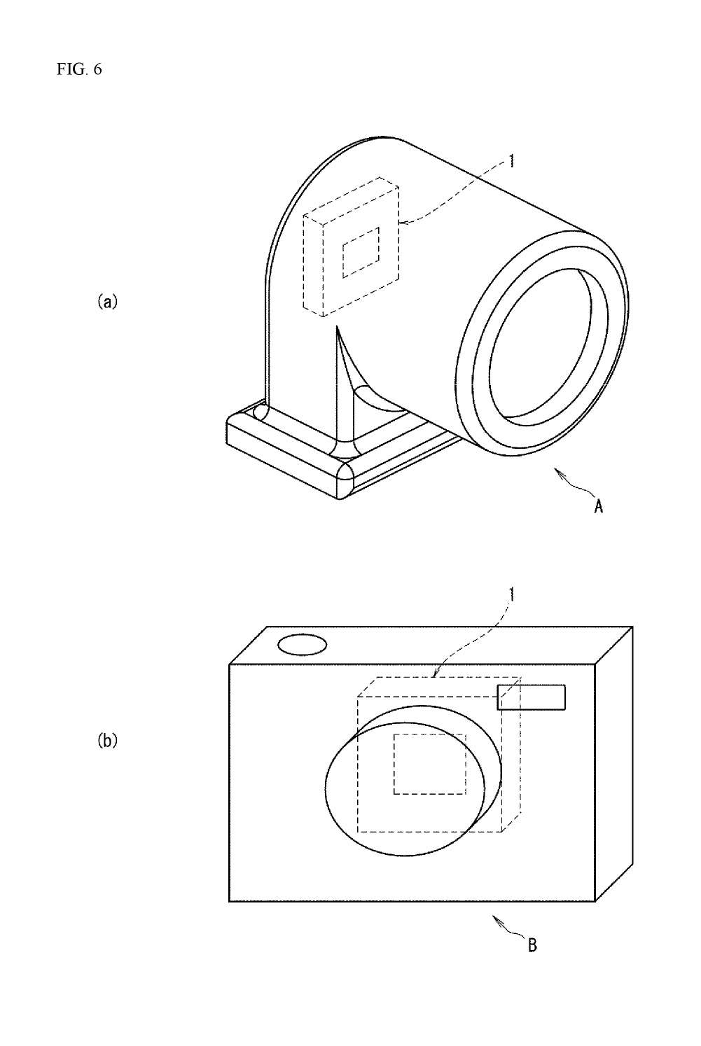

The imaging unit as described above is depicted in FIG. 6(a) and (b).

Imaging device A, illustrated in FIG. 6(a), is an example of an infrared radiation camera (a night vision camera), equipped with a blade driving device 1, a lens that is positioned to the front of the blade driving device 1, a photodetecting element, a processing circuit for processing an image signal that is captured by the photodetecting element, a memory, and the like, within a casing.

Imaging device B, as illustrated in FIG. 6(b), is an example of a digital camera, equipped with a blade driving device 1, a lens that is positioned to the front of the blade driving device 1, a photodetecting element, a processing circuit for processing an image signal that is captured by the photodetecting element, a memory, and the like, within a casing.

The imaging devices A and B have relatively small structures, with good ease of operation as well, through the structure, described above, for the blade driving device 1.

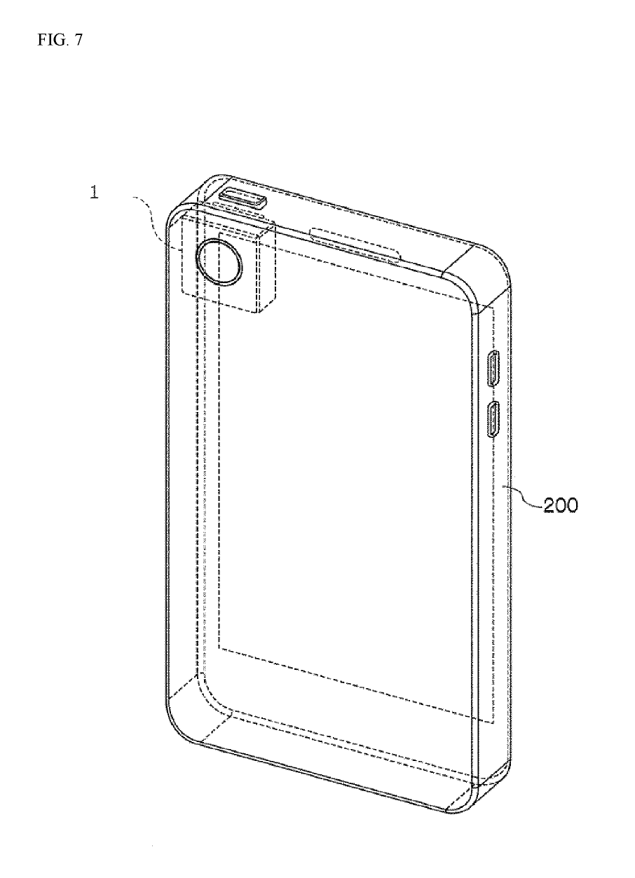

Moreover, the blade driving device 1 can be applied not only to these imaging devices A and B, but also to the mobile device 200 depicted in FIG. 7, and to vehicle-mounted devices, and the like, as well.

Note that while in the embodiment described above the yoke 60 is shaped with one edge side bent into a cross-sectional essentially L-shape, along the base plate 10 that has a cross-sectional L-shape, the base plate 10 may be formed instead into an essentially flat plate-shape, and the yoke 60 may be formed into a flat plate-shape along the blade supporting face of the base plate 10.

Moreover, while in the present embodiment the blade driving device 1 was assembled into the camera module in such a way that the side to which the supporting piece 12 protrudes will be on the imaging subject side, in another embodiment it may be assembled into a camera module in such a way that the side to which the supporting piece 12 protrudes is on the sensor side instead, that is, the opposite of the form described above.

Moreover, while in the embodiment set forth above, as a particularly preferred form, the first coil 70 and the second coil 80 were coiled in mutually opposite directions, with the terminals thereof connected at the center, instead the first magnetic pole portion 61 and the second magnetic pole portion 62 may be of the same polarity with the connecting portions 63 and 64 connected with opposite polarities at the center thereof, or, as another example, the first coil 70 and the second coil 80 need not have the center terminals connected, but instead may be coiled in the same direction, with the polarities described above produced through control of the electric power that is supplied to the individual coils.

Moreover, the first magnet 40, the second magnet 50, the yoke 60, the first coil 70, and the second coil 80, together, are termed an “actuator.”

Additionally, as another embodiment, the structure need not include the third magnetic pole portion 66 and the fourth magnetic pole portion 67 that are included in the yoke 60. In other words, a structure is possible wherein the third magnetic pole portion 66, the fourth magnetic pole portion 67, and the connecting piece 65 are omitted from the yoke 60. This makes it possible to make the actuator even smaller, enabling the blade driving device 1 to be made even smaller.

Moreover, as another embodiment, in the plan view the first magnet 40 and the second magnet 50 may be polygons, for example, hexagons, or the like, instead of circles.

While embodiments according to the present invention were described in detail above, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. A blade driving device, comprising:
a base plate comprising an opening for an optical path;
a first blade and a second blade, at different locations on the base plate, and that each rotate to open/close the opening;
a first magnet secured around an axis of rotation of the first blade;
a second magnet secured around an axis of rotation of the second blade;
a yoke secured on the base plate; and
a first coil and a second coil coiled on the yoke, wherein:
the yoke comprises:
a first magnetic pole portion that is adjacent to the first magnet,
a second magnetic pole portion that is adjacent to the second magnet, and
a connecting portion for connecting the first magnetic pole portion and the second magnetic pole portion; and
wherein the first magnetic pole portion and the second magnetic pole portion each comprise:
an adjacent piece that is adjacent to the corresponding magnet, and
an extending portion that is continuous with the adjacent piece and that is provided extending in a direction that is perpendicular to the blade supporting face of the base plate.

2. The blade driving device as set forth in claim 1, wherein:
the first coil and the second coil are each provided on the connecting portion.

3. The blade driving device as set forth in claim 1, wherein:
the first coil and the second coil are electrically connected so they have the same polarity as the first magnetic pole portion and the second magnetic pole portion, and so that the vicinity of a center thereof has a polarity that is opposite of that of the first magnetic pole portion and the second magnetic pole portion.

4. The blade driving device as set forth in claim 1, wherein:
the connecting portion connects the extending portion of the first magnetic pole portion side and the extending portion of the second magnetic pole portion side so as to be collinear.

5. The blade driving device as set forth in claim 1, wherein:
in the yoke, the adjacent pieces in the first magnetic pole portion and the second magnetic core portion are disposed on the blade supporting surface side of the base plate, and the extending portion and the connecting portion are disposed are one side surface of the base plate.

6. The blade driving device as set forth in claim 1, wherein:
the adjacent portion of the first magnetic pole portion and the adjacent portion of the second magnetic pole portion are each provided adjacent to one side, in the radial direction, of the respectively corresponding magnets;
the yoke further comprises a third magnetic pole portion extending from the connecting portion and adjacent to the adjacent piece on the other side, in the radial direction, in respect to the first magnet, and a fourth magnetic pole portion that is adjacent to the adjacent piece on the other side, in the radial direction, in respect to the second magnet; and
the adjacent piece of the third magnetic pole portion and the adjacent piece of the fourth magnetic pole portion are connected in a single unit and connected to the connecting portion.

7. An imaging device comprising a blade driving device as set forth in claim 1.

8. An actuator comprising:
a first magnet and a second magnet that are each supported so as to enable rotation, a yoke, and a first coil and a second coil that are wound on the yoke, wherein:
the yoke comprises a first magnetic pole portion that corresponds to the first magnet, a second magnetic pole portion that corresponds to the second magnet, and a connecting portion for connecting the first magnetic pole portion and the second magnetic pole portion; and
the first magnetic pole portion and the second magnetic pole portion each comprise an adjacent piece that is near to one side, in the radial direction, in respect to the corresponding magnet, and an extending portion that is provided extending in a direction that is perpendicular in respect to this adjacent piece.
